(19) United States
(12) Patent Application Publication
(10) Pub. No.: US 2008/0219769 A1
(43) Pub. Date: Sep. 11, 2008

(54) ROOT-IRRIGATION PIPE AND ROOT-IRRIGATION SYSTEM

(76) Inventors: Rongwu Ding, Quanzhou (CN); Zhangli Lin, Jinjiang City (CN)

Correspondence Address: GREER, BURNS & CRAIN, 300 S WACKER DR, 25TH FLOOR, CHICAGO, IL, 60606, US

(21) Appl. No.: 12/044,657

(22) Filed: Mar. 7, 2008

(30) Foreign Application Priority Data
Mar. 7, 2007 (CN) 200720006480.8

(51) Int. Cl. E02B 13/00; A01G 29/00

(52) U.S. Cl. 405/45; 239/145

(57) ABSTRACT

A root-irrigation pipe, including a hollow pipe with holes in two terminals, an inside of said pipe is parted into a first side-chamber and a second side-chamber by a separate-wall extending longitudinally. A sidewall of the first side-chamber opposite said separate-wall has an opening extending lengthwise, the separate-wall distributing perforative orifices uniformly lengthwise; a plurality of blocks distributed lengthwise are slidably located between said first side-chamber and the opening, blocking the orifices, a space between the block and the flank of said first side-chamber forming a seeping-cleft with an edge of the opening.

### FIELD OF THE INVENTION

The present invention relates to a Root-irrigation pipe and Root-irrigation system for agriculture

### BACKGROUND OF THE INVENTION

Subsurface irrigation as a kind of high-efficient water-saving irrigation technology had receive more and more attention in the irrigation field of agriculture. Said subsurface irrigation is to bury the leaky pipe underground, the water (or liquid fertilizers pesticide, gas) is transported through the pipe and seeping to the soil from orifices, penetrate to the roots zone of crop by capillarity and absorbed by the roots of crops.

Subsurface irrigation has many advantages contrasts with traditional irrigation technology. For example, the subsurface irrigation system transports the water through the pipe, no water loss; The soil surface has a low content water, lower surface evaporation; The water supply could adjusted precisely according to the water consumption of corps, high efficient water-utilization and well water-saving effects; the water transported in low pressure, lower energy consumption and well energy-saving effects; it doesn't destroy the structure of the soil, and the surface soil maintain ventilative; it can achieve the objects of transporting the waters fertilizers pesticides gas uniformly and adjusted automatically, providing a stable growing environment for crop growth, having a significant corps yield increase effect; it occupy few farm, seldom interfere the motion of farm machinery, the field management or the field transportation, low maintenance cost, easy to implement automatic management; the surface soil maintain a relatively dry status, it is beneficial to weed control and insect pest control. The disadvantages of subsurface irrigation are as follows: the orifices of leaky pipe are easy to be jammed; low humidity content of surface soil is dis-beneficial to the seedling and seedling growth of corps. there still be some runoff in pervious soil zone; hard to be examined and repaired, high investment cost and many construction labor; burying of leaky pipe is restricted by the length of pipe and the gradient of terrain; it is easy accumulating salt in the surface soil if the irrigation flow is too small. and it is inapplicable in saline-alkali land. In all above mentioned disadvantages, the orifices of leaky pipe being easy-jammed is the most serious problem in the existing subsurface irrigation system, which directly affect the application of the irrigation system. on one side, the orifices-jam make the fluid flow reduced or even no flow pass through the orifices, thus affect the growth of corps. On the other side, it change the pressure distributing in the pipeline, alter the uniformity of the water flow. the total irrigation system can not operate normally or even have to be disassembled.

The cause why the orifices of leaky pipe is to being easy-jammed is that: normally the supported flow is very small to 1˜10 L/h., the aperture of the orifices must be very small to match the small flow, normally to be less than 1 mm, the aperture of common leaky pipe orifices is 0.5 mm, and aperture of inline leaky/drip irrigation pipe orifices is less than 01. mm averagely. Aperture of micro-leakage pipe orifices is less than 0.06 mm. The small aperture orifices are easy jammed when they are twisted by crop roots, or imbibe the soils and sands into pipe by negative-pressure which caused in moment of the cease of water flow, or when there are too many sediments of soil and sand grains, water scale, organism and un-degraded organic-impurity in irrigation water. The jammed of leaky pipe lessen the irrigation water flow, bring the following problems: firstly, it caused the rise of the salt and alkali in the rock bottom by capillary which taken the secondary salinization; secondly, there are not enough water support when the crop growing up, which restrict the crop growth or even make the crop death, for the above-mentioned reason, the existing subsurface irrigation system cannot apply effectively in drought area and saline-alkali area.

To solve the problem of the easy-jammed orifices of leaky pipe, the inventor of the present invention have invented a novel pipe and a water-saving device composed of the pipe, which has being in public of the china invention patent, and the authorization number is CN1253074 (Publication date: Apr. 26, 2006). the novel pipe and irrigation system not only have the advantages of existing subsurface irrigation system, but also have special anti-jammed capability and well irrigation effect. However, the apply results of the novel pipe and irrigation system shows that they are still to being improved, for example, the water seeped out through both sides of pipe, it shortens the water transporting distance; the orifices in both sides must be balanced in a horizontal line when the pipe buried into soil. which is not beneficial to installing the system rapidly, simply and conveniently; There are seeping part in the protruding of pipe ektexine, thus the shape of pipe is irregular, which cannot match with existing standard pipeline connectors, it must design and equip special connector, thus increase the manufacture and install cost; the pipe made by hard material, thus the pipe burying restricted to the terrain.

### SUMMARY OF THE INVENTION

A primary object of this invention is to provide a root-irrigation pipe to solve the existing problem above mentioned.

Another object of this invention is to provide a root-irrigation system to solve the existing problem above mentioned.

The root-irrigation pipe of the present invention characterized in that it comprising: a hollow pipe with holes in two terminals, the inside of said pipe is parted into first side-chamber and second side-chamber by a separate-wall which extending in length direction. The sidewall of said first side-chamber opposite said separate-wall having a opening which extending in length direction, said separate-wall distributing perforative orifices uniformly in length direction; blocks distributed in length direction, which locate slidable between said first side-chamber and said opening, blocking said orifices, the space between said block and the flank of said first side-chamber form a seeping-cleft with the edge of opening.

Preferably, said opening corresponding to said orifices in height.

Preferably, said orifices located in the middle position of said separate-wall in height.

Preferably, said separate-wall is a straight wall.

Preferably, said block having basic part and protrusive part, and said basic part locate movably in said first side-chamber, said protrusive part locate movably in said opening, the space between the basic part of said block and the flank of said first side-chambers and the space between the protrusive part and the opening edge form seeping-clefts.

Preferably, said hollow pipe and said block are made of hard plastic.

Preferably, said hollow pipe and said block are made of flexible plastic.

The root-irrigation system provided in the present invention characterized in that it composing: head junction; transportation pipe, connecting with said head junction; root-irrigation pipe, connecting with said transportation pipe, said root-irrigation pipe including hollow pipe with holes in two terminals, the inside of said pipe is parted into first side-chamber and second side-chamber by a separate-wall which extending in length direction. The sidewall of said first side-chamber opposite said separate-wall having a opening which extending in length direction, said separate-wall distributing perforative orifices uniformly in length direction; blocks distributed in length direction, which locate slidable between said first side-chamber and said opening, blocking said orifices, the space between said block and the flank of said first side-chamber form a seeping-cleft with the edge of opening.

Preferably, said head junction composing water tank, said water tank having filter inside.

Preferably, said transportation pipe having sandbasin device and drain valve.

The Root-irrigation pipe and Root-irrigation system provided in the present invention, besides the known advantages of existing subsurface irrigation system, and special anti-jammed capability and fine irrigation effect, they also have the advantages as follows: because the irrigation pipe seep only on one side, thus the water transporting distance lengthen and irrigation effect increased; it need not keep the orifices of both sides balancing in one horizontal line when the pipe buried into soil, thus the difficulty of installation decreased, which is beneficial to installing the system rapidly, simply and conveniently; The seeping part is inside the pipe, thus the shape of the pipe is cylinder, which can match with existing standard pipeline connectors, and need not design and equip special connector. it reduce the manufacture and install cost; the pipe could made by soft material, thus the pipe burying does not restricted by the terrain.

Detail structure and advantages of the present invention will be more clearly understood from the following detailed description taken in conjunction with the embodiments.

### BRIEF DESCRIPTION OF THE DRAWINGS

FIG. 1 is a cross sectional view of the root-irrigation pipe of the present invention.

FIG. 2 is a lengthwise sectional view of the root-irrigation pipe of the present invention.

FIG. 3 is a lengthwise sectional view of the block in the root-irrigation pipe of the present invention.

FIG. 4 is a top plan view of the root-irrigation system of the present invention.

FIG. 5 is an enlargement sectional view of the sandbasin device in the root-irrigation system of the present invention.

FIG. 6 is a burying plan view of the root-irrigation pipes in the root-irrigation system of the present invention.

FIG. 7 is a sectional view of the root-irrigation system of the present invention. In which the root-irrigation pipes set up adapted to the terrain.

### DETAILED DESCRIPTION OF THE INVENTION

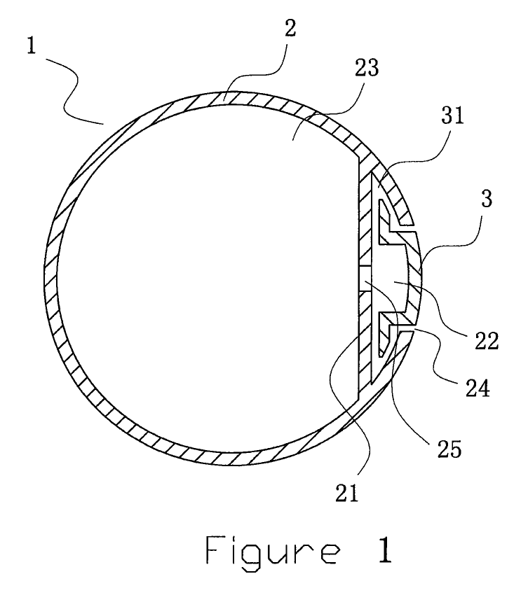

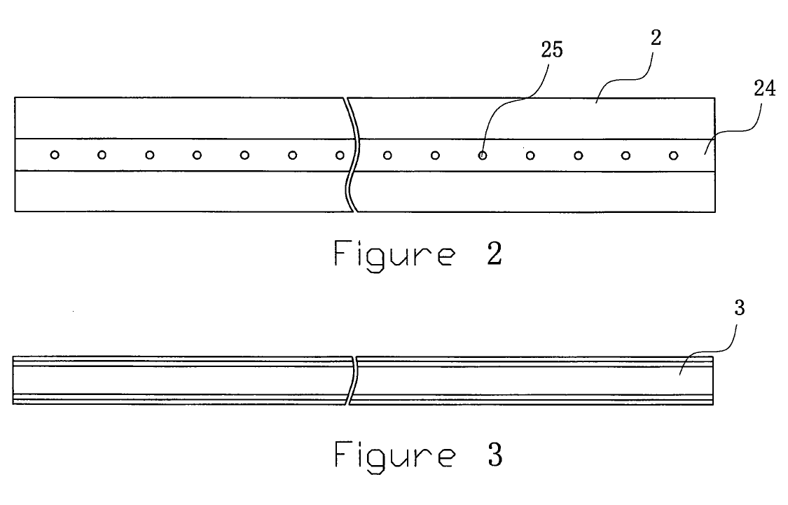

According to FIG. 1 to FIG. 3, the root-irrigation pipe 1 including pipe body 2 and block 3, preferably, the material of them is hard plastic or flexible plastic, the following materials is usable but without limitation: Polyethylene (PE) and polyvinylchloride (PVC). Preferred material of hard pipe is PVC and Preferred material soft pipe is PE. The diameter of the pipe including: φ110 mm, φ75 mm, φ50 mm, φ32 mm, φ25 mm, φ20 mm, φ16 mm. etc. the length of the pipe longer than 4 mm. In condition of avoid light and heats constant humid and temperature, the pipe buried in the soil can use long than 20 years.

Pipe body 2 is a hollow cylinder with holes in two terminals. the inside of pipe body is parted into first side-chamber 22 and second side-chamber 23 by the separate-wall 21 which extending in length direction. The sidewall of the first side-chamber 22 opposite the separate-wall 21 having opening 24 which extending in length direction, separate-wall 21 having many perforative orifices 25 along lengthwise; orifices 25 located in the middle of separate-wall 24 in height, and opening 24 corresponding to orifices 25 in height. the aperture and the between-distance of orifice 25 could made according to need. Commonly the aperture is 4 mm, 3.5 mm, 2.5 mm, 2.0 mm, 1.5 mm, and the between-distance is 400 mm to 800 mm.

Blocks 3 locate slidable between first side-chamber 22 and opening 24, and block orifices 25, block 3 having basic part and protrusive part, Their out shape corresponding with the first side chamber 22 and opening 24. the basic part of block 3 locate movably in the first side-chamber 22, and protrusive part of block 3 locate movably in opening 24. the space between the basic part of block 3 and the flank of first side-chamber 22, and the space between the protrusive part and the edge of opening 24 form seeping-cleft 31. the width of seeping-cleft 31 is 0.5 mm.

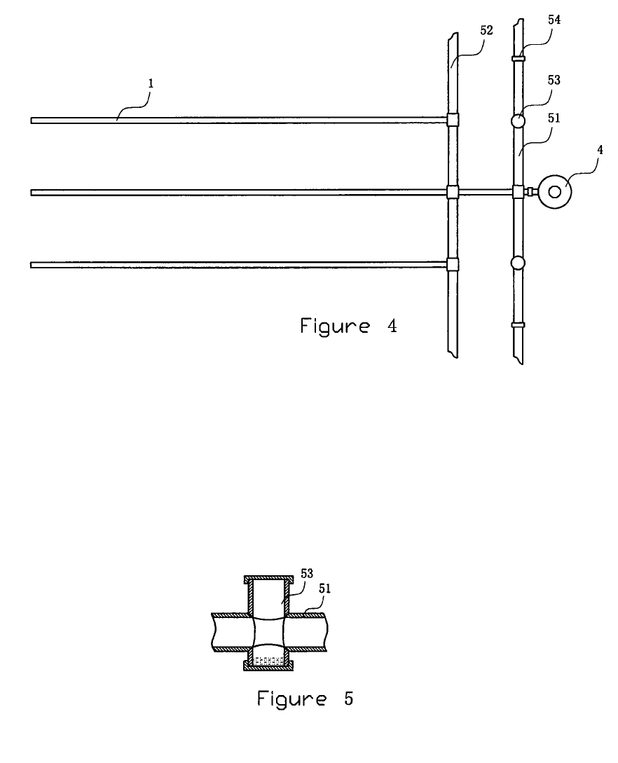

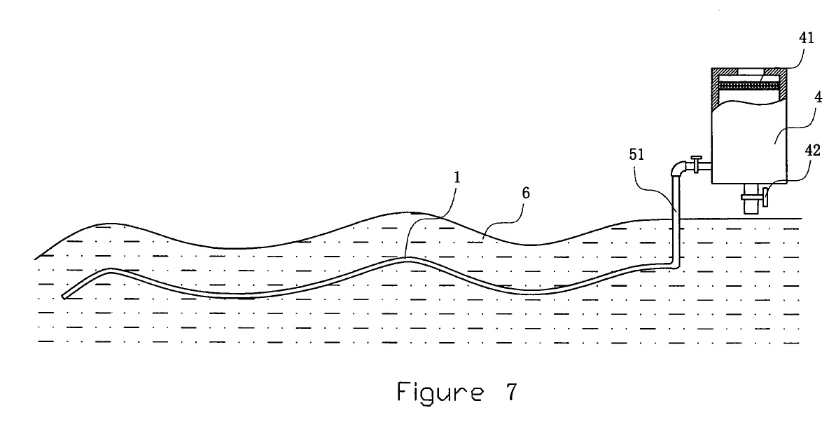

According to FIG. 4 to FIG. 7, The root-irrigation system of the present invention composing head junctions transport pipe and root-irrigation pipe 1. head junction setting on the soil surface, including water tank 4 and the other device i.e. water pump, fertilizer and medicament injection devices control devices adjust device, measure device etc. water tank 4 having enter hole and exit hole, and having sewage draining hole in the bottom, there are double-layer net filter 41 in both enter hole and exit hole, sewage draining valve 42 is in sewage draining hole. It can choose filter of 20 to 80 mesh according to water quality.

transportation pipe are buried in subsurface soil, main pipe 51 and branch pipe 52 composed pipe net, the main pipe 51 connected with the enter hole 41 of water tank 4. transportation pipe having sandbasin device 53, the terminal having exit hole, and water drain valve 54 in exit hole as is shown in FIG. 5.

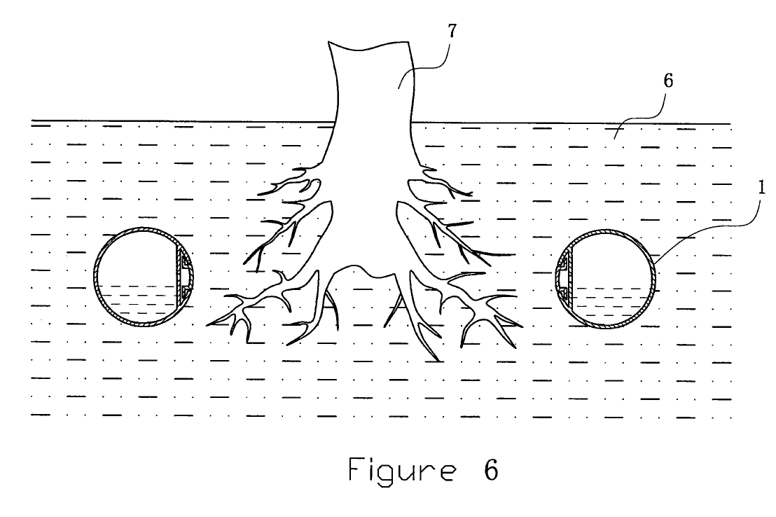

root-irrigation pipe 1 connected with branch 52, and the connection can taken existing standard connectors because the pipe body shape is cylinder. As is shown in FIG. 6, root-irrigation pipe 1 buried in the soil layer 6 of the root zone of crop 7 in subsurface, the depth of the burying is 30 cm to 60 cm according to irrigation need and crop species.

Detail capability description of root-irrigation pipe and root-irrigation system of the present invention.

(1) it not only having the advantages of existing subsurface irrigation system in irrigation capability aspect, but also has some specialties as follows:

The water seep only on one side of root-irrigation 1, it prolongs the water transportation distance, increase the irrigation efficiency.

The irrigation water could be transported to soil in liquid state or gaseous. When irrigate the crop, besides part of the water in root-irrigation pipe seeping out to moist the soil through the seeping-cleft 31 and opening 24 in the first side-chamber 22, there are nearly half water in pipe in the second side chamber-23 (if the root-irrigation pipe 1 set in plane), The rest water in the second side-chamber 23 will evaporate slowly, and extravasate from the seeping-cleft 31 and opening 24, and absorbed by crop after recoagulated, thus achieve the object of longtime balanced irrigation.

Stronger irrigate capability, for example, the irrigate capability a root-irrigation pipe of diameter φ20 mm could adjusted between 15L/h·m to 35 L/h·m, that is beneficial to restrain the rise of saline and alkali from the bottom soil. The water could pervade more area in the subsurface, thus favorable to the root growth of crop.

Lower transportation pressure, less energy consumption and better irrigation effect than common seeping irrigation.

Could be use in transporting remedy i.e. saline-alkali soil amendment to improve soil behavior, promote the microbes growth, solve the problem of common subsurface irrigation can not apply in saline-alkali land.

Could used as both irrigation and drainage, making the best of rainfall and preventing waterlogging.

(2) well anti-jammed ability: firstly, the water will be filtered in the filter device in tank 4 before it enters the transportation pipe and root-irrigation pipe. Moreover, the tank 4 can use clapboard to deposit the impurity, then the deposited impurity can be drained through the sewage hole in the bottom of tank 4.

Secondly, there is sand basin device in the transportation pipe, where the small impurities entered in pipeline carrying in the water will be deposited. Observing through the air hole of the sand basin device which is higher than the floor, if the deposited impurities is too many to be clear, we could open the drain valve 54 in the exit hole, push the deposit out of the pipe by water impulsive force. Moreover, the inside wall of transportation pipe and root-irrigation is smooth, the impurities and other deposit can hardly adhering to the wall, easy to be drain out.

Thirdly, the special structure design of irrigation pipe make it be anti-jammed. The water seeping out by two steps, the first seeping step is through the orifices 25, the orifices 25 is uneasy to be jammed because the aperture of orifices are quite big, the second seeping step is through the seeping-cleft 31 and opening 24, the opening 24 can not jammed everywhere because it is long extending to the whole pipe in lengthwise, part-jammed does not effect the irrigation. Moreover, the bar of block 3, the zigzag flow way of the seeping-cleft 31, the lower negative-pressure, lower transportation pressure which caused in moment of the cease of water flow, all above reasons make the soils and sands hardly imbibed into pipe, which prevent the jamming.

Fourthly, the pipes in all levels remain about half water inside the pipe after every irrigations except the necessary seeping water. The remain water composing all kind of organic and inorganic nutrilite, processing the anaerobic biodegradation under the relatively steady temperature and humid condition, the organic will decompose into CH₄, CO₂ and H₂S etc. to form a acidic condition, which can eliminate the problem of organic jamming.

(3) can construct the system rapidly, simply and conveniently: firstly, the root-irrigation pipe 1 could be installed in a plane as is shown in FIG. 6 or be installed in uprightness. When the root-irrigation pipe 1 made of flexible soft material, under some transportation pressure, the root-irrigation pipe can also be installed according to the hypsography. the root-irrigation pipe 1 widen its usable area for its installations does not restrict to the terrain. When the root-irrigation pipe 1 installed in plane, the opening 24 may setting towards to the level direction or under level direction. secondly, The seeping part of root-irrigation pipe 1 located inside the pipe, thus the shape of pipe is cylinder, which can match with existing standard pipeline connectors, it need not design and equip special connector, thus reduce the cost.

The foregoing description of the exemplary embodiment of the invention has been presented for the purposes of illustration and description. It is not intended to be exhaustive or to limit the invention to the precise form disclosed. many modifications and variations are possible in light of the above teaching. It is intended that the scope of the invention be limited not with detailed description, but rather by the claims appended hereto.

1. A root-irrigation pipe comprising: a hollow pipe with holes in two terminals, the inside of said pipe is parted into a first side-chamber and a second side-chamber by a longitudinally separate-wall; a sidewall of said first side-chamber extending opposite said separate-wall having an opening which extends lengthwise, said separate-wall distributing perforative orifices uniformly in length direction; a plurality of blocks distributed lengthwise, which locate slidably between said first side-chamber and said opening, blocking said orifices, the space between said block and a flank of said first side-chamber forming a seeping-cleft with the edge of opening.

2. The root-irrigation pipe according to claim 1, wherein said opening corresponds to said orifices in height.

3. The root-irrigation pipe according to claim 1, wherein said orifices are located in a middle height position of said separate-wall.

4. The root-irrigation pipe according to claim 1, wherein said separate-wall is a straight wall.

5. The root-irrigation pipe according to claim 1, wherein said block has a basic part and a protrusive part, and said basic part is movably located in said first side-chamber, said protrusive part is movably located in said opening, a space between the basic part of said block and a flank of said first side-chamber, and a space between the protrusive part and an opening edge forming seeping-clefts.

6. The root-irrigation pipe according to claim 1, wherein said hollow pipe and said block are made of hard plastic.

7. The root-irrigation pipe according to claim 1, wherein said hollow pipe and said block are made of flexible plastic.

8. A root-irrigation system comprising: a head junction; a transportation pipe, connecting with said head junction; a root-irrigation pipe, connecting with said transportation pipe, said root-irrigation pipe including a hollow pipe with holes in two terminals, the inside of said pipe parted into a first side-chamber and a second side-chamber by a separate-wall extending lengthwise; a sidewall of said first side-chamber opposite said separate-wall having an opening which extending lengthwise, said separate-wall distributing perforative orifices uniformly lengthwise; a plurality of blocks distributed lengthwise are solidably located-between said first side-chamber and said opening, blocking said orifices, the space between said block and a flank of said first side-chamber form a seeping-cleft with an edge of the opening.

9. The root-irrigation system according to claim 8, wherein said head junction comprises a water tank, said water tank having a filter inside.

10. The root-irrigation system according to claim 8, wherein said transportation pipe has a sandbasin device and a drain valve.
